(19) United States
(12) Patent Application Publication
(10) Pub. No.: US 2014/0293050 A1
(43) Pub. Date: Oct. 2, 2014

(54) Fire Alarm and Surveillance System

(71) Applicant: Shenzhen Guangan Fire-Fighting & Decoration Engineering Co., Ltd., Shenzhen (CN)

(72) Inventor: Shaobin LI, Shenzhen (CN)

(73) Assignee: Shenzhen Guangan Fire-Fighting & Decoration Engineering Co., Ltd., Shenzhen (CN)

(21) Appl. No.: 14/163,514

(22) Filed: Jan. 24, 2014

(30) Foreign Application Priority Data
Apr. 1, 2013 (CN) 201310111294.0

(51) Int. Cl. G08B 17/12

(52) U.S. Cl. CPC G08B 17/125
USPC 348/143

(57) ABSTRACT

A fire alarm and surveillance system includes a manual fire alarm activator, a main control unit electrically connecting to the manual fire alarm activator, and a surveillance system electrically connecting to the main control unit. When the manual fire alarm activator is triggered, the manual fire alarm activator is arranged to send a corresponding signal to the main control unit, and trigger the surveillance system to capture a visual video of the predetermined area.

### CROSS REFERENCE OF RELATED APPLICATION

This is a non-provisional application that claims the benefit of priority under 35 U.S.C. §119 to a foreign application number 201310111294.0, filing date Apr. 1, 2013 in China. The contents of this specification are incorporated herein by reference.

### BACKGROUND OF THE PRESENT INVENTION

1. Field of Invention

The present invention relates to a fire alarm system, and more particularly to a manual fire alarm and surveillance system which is capable of capturing a video of a location where fire occurs.

2. Description of Related Arts

Many cities around the world have been developing very rapidly, and they may have very high population and require a large number of high-rise buildings and large-scale industrialization. Because of these developments, their need for stable and reliable power supply is increasing very rapidly. These large-scale developments and industrialization become the source of potential fire hazard. At the same time, however, the awareness of fire safety among people in these cities is decreasing. Conflagration can cause a large number of deaths and injuries.

When fire occurs, the single most important task is to accurately ascertain the source of the fire and combat the fire so as to prevent it from rapidly spreading to other areas. Conventional fire alarm systems have been developed and widely utilized to enable people to alert others the occurrence of fire. For example, fire alert buttons have been installed on various locations of a building so that when fire occurs, people may manually trigger the fire alert buttons so as to trigger the fire alarm for alerting other people in that building the occurrence of fire.

A main feature of this type of fire alarm system is that, when compared to traditional fire detectors, the possibility of false alarm can be minimized because the triggering of the fire alert buttons is by a person who actually witnesses the occurrence of fire.

On the other hand, most commercial or residential buildings have installed surveillance system for security purpose. For example, a predetermined number of surveillance cameras may be installed on public areas of a commercial building so that a security guard may monitor the corresponding area of the building.

A major disadvantage of the conventional fire alarm system and the surveillance system as described above is that they work independently and do not work as a system for effectively alerting fire and promptly capturing the image or video in the area where the fire occurs. This is particularly important because the availability of the video of the fire scene may help firefighters to combat an ongoing fire, and may help the relevant authorities to gather evidence and investigate the cause of the fire. Moreover, conventional fire alert buttons are usually small in size, and are difficult to locate especially true when the fire occurs at night.

### SUMMARY OF THE PRESENT INVENTION

An objective of the present invention is to provide a fire alarm and surveillance system which is capable of capturing video at a location where fire occurs.

Another objective of the present invention is to provide a fire alarm and surveillance system which comprises a manual fire alarm activator and a surveillance system working together for alerting occurrence of fire, and for capturing the video of a predetermined area when the manual fire alarm activator is triggered.

Another objective of the present invention is to provide a fire alarm and surveillance system which can be used in a wide variety of situations, and can be centrally controlled to achieve the best co-ordination and co-operation between all the components of the present invention.

Another objective of the present invention is to provide a fire alarm and surveillance system which can be connected to governmental agencies so as to promptly alert relevant government agencies, such as the fire department, for providing prompt assistance to combat an ongoing fire.

In one aspect of the present invention, it provides a fire alarm and surveillance system comprising:

a manual fire alarm activator;

a main control unit electrically connecting to the manual fire alarm activator; and

a surveillance system electrically connecting to the main control unit, wherein when the manual fire alarm activator is triggered, the manual fire alarm activator is arranged to send a corresponding signal to the main control unit, and trigger the surveillance system to capture a visual video of the predetermined area.

In another aspect of the present invention, it provides a fire alarm and surveillance system, comprising:

a plurality of manual fire alarm activators;

a main control unit electrically connecting to the manual fire alarm activators; and

a surveillance system, which comprises:

a plurality of video capturing devices; and

a plurality of surveillance control devices electrically connecting to the main control unit and the video capturing devices respectively, wherein each of the surveillance control devices is arranged to process and store the video captured by the corresponding video capturing device, wherein when at least one of the manual fire alarm activators is triggered, the corresponding manual fire alarm activator is arranged to send a corresponding signal to the main control unit, and trigger the corresponding video capturing devices to capture a visual video of that predetermined area.

### BRIEF DESCRIPTION OF THE DRAWINGS

FIG. 1 is a block diagram of a fire alarm and surveillance system according to a preferred embodiment of the present invention.

FIG. 2 is a schematic diagram of the fire alarm and surveillance system according to the preferred embodiment of the present invention.

### DETAILED DESCRIPTION OF THE PREFERRED EMBODIMENT

The following detailed description of the preferred embodiment is the preferred mode of carrying out the invention. The description is not to be taken in any limiting sense. It is presented for the purpose of illustrating the general principles of the present invention.

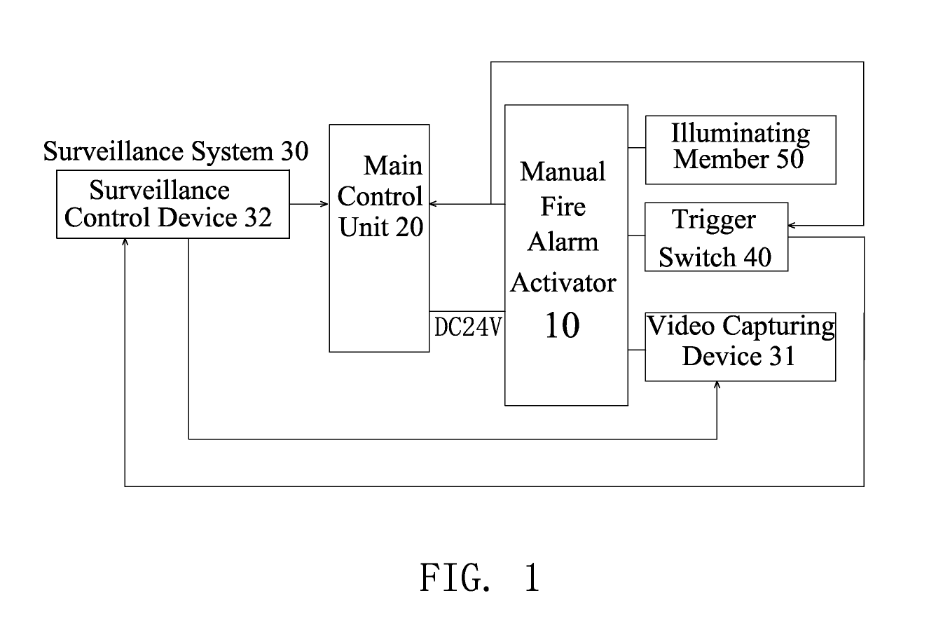

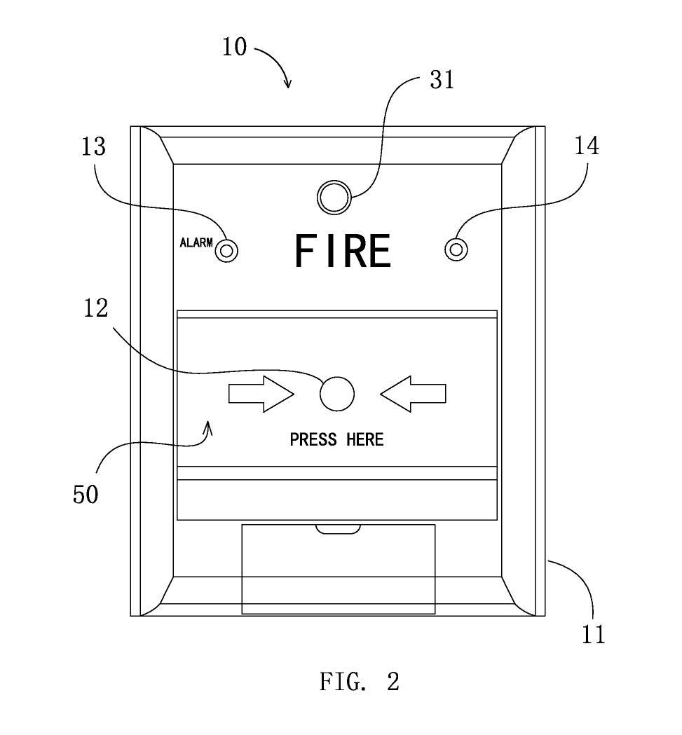

Referring to FIG. 1 to FIG. 2 of the drawings, a fire alarm and surveillance system according to a preferred embodiment of the present invention is illustrated. Broadly, the fire detection and surveillance system comprises at least one manual fire alarm activator 10, a main control unit 20 electrically connecting to the manual fire alarm activator 10, and a surveillance system 30 electrically connecting to the main control unit 20, wherein when the manual fire alarm activator 10 is triggered, the manual fire alarm activator 10 is arranged to send a corresponding signal to the main control unit 20, and trigger the surveillance system 30 to capture a visual video of the predetermined area.

According to the preferred embodiment of the present invention, the manual fire alarm activator 10 is arranged to be triggered by a person. The fire alarm and surveillance system may comprise a plurality of the manual fire alarm activators 10 providing on various locations of a building. When fire occurs, the person near the fire scene may be able to gain easy and convenient access to the nearest manual fire alarm activator 10 to initiate a fire alarm signal in a timely manner.

The main control unit 20 is electrically connected to the manual fire alarm activators 10, and is installed in a predetermined position of a building in which the fire alarm and surveillance system is implemented. The main control unit 20 is arranged to coordinate and control the operation of the manual fire alarm activators 10 and the surveillance system 30 so as to assist in monitoring the fire scene and combating fire. Furthermore, the main control unit 20 is electrically connect to the manual fire alarm activators 10 for supplying power to them. An exemplary voltage supplied to each manual fire alarm activator 10 is DC 24V.

When a predetermined manual fire alarm activator 10 is triggered, the manual fire alarm activator 10 is arranged to send an electrical signal to the main control unit 20. The main control unit 20 may be arranged to record the location of the fire, trigger an existing automated fire alarm system in the building, and alert the fire department.

The surveillance system 30 comprises a plurality of video capturing devices 31, and a plurality of surveillance control devices 32 electrically connecting to the main control unit 20 and the video capturing devices 31. Each of the surveillance control devices 32 is arranged to process and store the video captured by the corresponding video capturing devices 31.

It is worth mentioning that electrical connection between the surveillance system 30 and the main control unit 20 can be accomplished by conventional wired connection such as through phone cables, optical fibers, or by wireless connection such as through infrared radiation, microwaves etc. Thus, when fire occurs, the relevant persons, such as firefighters, security staff, or other persons may be able to monitor the fire scene through the main control unit 20 and the surveillance system 30. Moreover, the relevant authorities may also retrieve the video of the fire scene to investigate the possible cause of the fire. Security measures may be implemented on the main control unit 20 so as to restrict access of the video to authorized persons.

Referring to FIG. 1 of the drawings, the manual fire alarm activators 10 may be installed on every floor or every room of a building. Each of the manual fire alarm activators 10 is electrically connected to the main control unit 20 which is centrally installed on a predetermined location of the building, such as a control room of the building. Each of the manual fire alarm activators 10 has a unique address code programmed on the main control unit 20 so that when any one of the manual fire alarm activators 10 is manually triggered, the main control unit 20 may be able to identify which of the manual fire alarm activator(s) 10 is triggered, and the location of the relevant manual fire alarm activator(s) 10.

Referring to FIG. 2 of the drawings, each of the video capturing devices 31 is mounted on the corresponding manual fire alarm activator 10 so that each of the video capturing devices 31 is capable of capturing the image or video of the area in the vicinity of the corresponding manual fire alarm activator 10. This area is likely to be where the fire originates. The video capturing devices 31 are electrically connected to the surveillance control device 32.

According to the preferred embodiment of the present invention, each of the manual fire alarm activators 10 comprises a main body 11, a fire alarm button 12 operatively mounted on the main body 11, a fire indicator 13 provided on the main body 11, and a power indicator 14 also provided on the main body 11. When fire occurs, a person at the fire scene may easily presses on the fire alarm button 12. When the fire alarm button 12 is triggered, a corresponding signal is sent to the main control unit 20, which identifies the identity and location of the manual fire alarm activator 10, and sends a fire signal to the automated fire suppression system in the building, and notifies the relevant authorities (such as the fire department) the occurrence of fire.

Referring to FIG. 2 of the drawings, each of the manual fire alarm activators 10 further comprises an illuminating member 50 providing on the main body 11, wherein the illuminating member 50 is arranged to provide illumination for allowing a person to promptly and accurately locate the corresponding manual fire alarm activator 10, especially when the fire occurs at night. Specifically, the illuminating member 50 is configured from a material which is capable of generating illumination in dark environment. For example, the illuminating member 50 may be configured from fluorescent material which absorbs light during daytime while releasing fluorescent illumination during nighttime. Alternatively, the illuminating member 50 may be configured as a layer of self-illuminating or fluorescent paint applied on the main body 11 for allowing others to accurately and promptly identify the location of the corresponding manual fire alarm activator 10. In this preferred embodiment of the present invention, the illuminating member 50 comprises a self-illuminating thin film adhered to a front surface of the main body 11 of each of the manual fire alarm activators 10. Alternatively, the illuminating member 50 may be embodied as a photo-luminescent material made from alkaline earth aluminate. The photo-luminescent material may be in the form of powder or a thin film. They absorb and store light during daytime while generating illumination during nighttime.

According to the preferred embodiment of the present invention, each of the video capturing devices 31 is mounted on the main body 11 of the corresponding manual fire alarm activator 10. When the manual fire alarm activator 10 is triggered by depression of the fire alarm button 12, the corresponding video capturing device 31 is also triggered to capture a video of the area in front of the corresponding manual fire alarm activator 10.

The surveillance system 30 further comprises a plurality of trigger switches 40 electrically connecting between each of the surveillance control devices 32 and the corresponding manual fire alarm activator 10. According to the preferred embodiment of the present invention, when the manual fire alarm activator 10 is triggered by a depression of the fire alarm button 12 and sends a corresponding signal to the main control unit 20, the corresponding trigger switch 40 is also triggered to switch on the corresponding surveillance control device 32 for activating the video capturing device 31 which is electrically connecting to the surveillance control device 32. Each of the trigger switches 40 may be embodied as a relay. When the manual fire alarm activator 10 is not triggered, the relay cuts off the electricity supplied to the corresponding surveillance control device 32. When the manual fire alarm activator 10 is triggered and sends an electrical signal to the main control unit 20, the electrical signal triggers the trigger switch 40 which allows electricity to be supplied to the surveillance control device 32. The surveillance control device 32 is then arranged to turn on the corresponding video capturing device 31 for capturing the video of the area in the vicinity of the corresponding manual fire alarm activator 10. Note also that each of the surveillance control devices 32 is designated an address code which is identical to that of the corresponding manual fire alarm activator 10.

The operation of the present invention is as follows: when fire occurs, a person in the building may locate the nearest manual fire alarm activator 10 and depress the fire alarm button 12 for a predetermined period of time (e.g. 3-5 seconds). The manual fire alarm activator 10 is then arranged to send electrical signals to the main control unit 20 and the corresponding fire indicator 13 will be turned on. These electrical signals trigger the trigger switches 40 for supplying electricity to the surveillance control device 32 which drives the corresponding video capturing device 31 to operate. The video capturing device 31 is then arranged to capture the video of the fire scene. The main control unit 20 will be able to identify the location of the fire by identifying the address code assigned to the corresponding manual fire alarm activator 10.

The present invention, while illustrated and described in terms of a preferred embodiment and several alternatives, is not limited to the particular description contained in this specification. Additional alternatives or equivalent components could also be used to practice the present invention.

What is claimed is:

1. A fire alarm and surveillance system, comprising:
a manual fire alarm activator;
a main control unit electrically connecting to said manual fire alarm activator; and
a surveillance system electrically connecting to said main control unit, wherein when said manual fire alarm activator is triggered, said manual fire alarm activator is arranged to send a corresponding signal to said main control unit, and trigger said surveillance system to capture a visual video of said predetermined area.

2. The fire alarm and surveillance system, as recited in claim 1, wherein said surveillance system comprises at least one video capturing device, and at least one surveillance control device electrically connecting to said main control unit and said video capturing device, wherein said surveillance control device is arranged to process and store said video captured by said corresponding video capturing device.

3. The fire alarm and surveillance system, as recited in claim 2, wherein said video capturing device is mounted on said corresponding manual fire alarm activator so that said video capturing device is capable of capturing a video of an area in the vicinity of said corresponding manual fire alarm activator.

4. The fire alarm and surveillance system, as recited in claim 1, wherein said manual fire alarm activator comprises a main body, a fire alarm button being operatively mounted on said main body, and a fire indicator providing on said main body.

5. The fire alarm and surveillance system, as recited in claim 3, wherein said manual fire alarm activator comprises a main body, a fire alarm button being operatively mounted on said main body, and a fire indicator providing on said main body.

6. The fire alarm and surveillance system, as recited in claim 2, wherein said surveillance system further comprises a plurality of trigger switches electrically connecting between said surveillance control device and said corresponding manual fire alarm activator, wherein when said manual fire alarm activator is triggered, and sends a corresponding signal to said main control unit, said corresponding trigger switch is also triggered to switch on said corresponding surveillance control device for activating said video capturing device.

7. The fire alarm and surveillance system, as recited in claim 5, wherein said surveillance system further comprises a plurality of trigger switches electrically connecting between said surveillance control device and said corresponding manual fire alarm activator, wherein when said manual fire alarm activator is triggered by a depression of said fire alarm button, and sends a corresponding signal to said main control unit, said corresponding trigger switch is also triggered to switch on said corresponding surveillance control device for activating said video capturing device.

8. The fire alarm and surveillance system, as recited in claim 6, wherein said trigger switch comprises a relay which normally cuts off electricity supplied to said surveillance control device, and when said manual fire alarm activator is triggered and sends an electrical signal to said main control unit, said electrical signal triggers said trigger switch which allows electricity to be supplied to said surveillance control device for activation thereof.

9. The fire alarm and surveillance system, as recited in claim 7, wherein said trigger switch comprises a relay which normally cuts off electricity supplied to said surveillance control device, and when said manual fire alarm activator is triggered and sends an electrical signal to said main control unit, said electrical signal triggers said trigger switch which allows electricity to be supplied to said surveillance control device for activation thereof.

10. The fire alarm and surveillance system, as recited in claim 1, wherein said manual fire alarm activator further comprises an illuminating member providing thereon, wherein said illuminating member is arranged to provide illumination for allowing a person to promptly and accurately locate said corresponding manual fire alarm activator.

11. The fire alarm and surveillance system, as recited in claim 9, wherein said manual fire alarm activator further comprises an illuminating member providing on said main body, wherein said illuminating member is arranged to provide illumination for allowing a person to promptly and accurately locate said corresponding manual fire alarm activator.

12. The fire alarm and surveillance system, as recited in claim 1, wherein said manual fire alarm activator has a unique address code programmed on said main control unit so that when said manual fire alarm activator is manually triggered, said main control unit is capable of identifying said manual fire alarm activator on said main control unit.

13. The fire alarm and surveillance system, as recited in claim 11, wherein each of said manual fire alarm activator and said video capturing device have a unique but identical address code programmed on said main control unit so that when said manual fire alarm activator is manually triggered, said main control unit is capable of identifying said manual fire alarm activator and said video capturing device on said main control unit.

14. The fire alarm and surveillance system, as recited in claim 10, wherein said illuminating member is configured from a layer of self-illuminating paint applied on said manual fire alarm activator.

15. The fire alarm and surveillance system, as recited in claim 11, wherein said illuminating member is configured from a layer of self-illuminating paint applied on said manual fire alarm activator.

16. The fire alarm and surveillance system, as recited in claim 10, wherein said illuminating member comprises a self-illuminating thin film adhered to a front surface of said manual fire alarm activator.

17. The fire alarm and surveillance system, as recited in claim 11, wherein said illuminating member comprises a self-illuminating thin film adhered to a front surface of said manual fire alarm activator.

18. The fire alarm and surveillance system, as recited in claim 10, wherein said illuminating member is configured from a photo-luminescent material made from alkaline earth aluminate.

19. The fire alarm and surveillance system, as recited in claim 11, wherein said illuminating member is configured from a photo-luminescent material made from alkaline earth aluminate.

20. A fire alarm and surveillance system, comprising:
a plurality of manual fire alarm activators;
a main control unit electrically connecting to said manual fire alarm activators; and
a surveillance system, which comprises:
a plurality of video capturing devices; and
a plurality of surveillance control devices electrically connecting to said main control unit and said video capturing devices respectively, wherein each of said surveillance control devices is arranged to process and store a video captured by said corresponding video capturing device, wherein when at least one of said manual fire alarm activators is triggered, said corresponding manual fire alarm activator is arranged to send a corresponding signal to said main control unit, and triggers said corresponding video capturing devices to capture a visual video of that predetermined area.
